(19) United States
(12) Patent Application Publication
(10) Pub. No.: US 2019/0303822 A1
(43) Pub. Date: Oct. 3, 2019

(54) Multi-User Asset Sharing and Risk Assessment System and Method

(71) Applicant: The Ago Companies LLC, Chicago, IL (US)

(72) Inventors: Jeremy Spoon, Chicago, IL (US); Ryan Murphy, Sarasota, FL (US)

(21) Appl. No.: 16/371,032

(22) Filed: Mar. 31, 2019

Related U.S. Application Data
(60) Provisional application No. 62/650,640, filed on Mar. 30, 2018.

(51) Int. Cl. G06Q 10/06

(52) U.S. Cl. CPC G06Q 10/0635

(57) ABSTRACT

A method for determining the risk profile of a vehicle driver, which includes monitoring payment timeliness of the vehicle driver, populating a risk database with the payment timeliness, wherein the risk database stores the payment timeliness data in a data field corresponding to the specific vehicle driver, monitoring braking style of the vehicle driver, populating a risk database with the braking style of the vehicle driver, wherein the risk database stores the braking style data in a data field corresponding to the specific vehicle driver, the braking style data includes the speed of the vehicle, pressure on a vehicle brake pedal by the vehicle driver, and the time the brake pedal is engaged by the vehicle driver, monitoring the speed of a vehicle being driven by the vehicle driver compared to the posted speed limit, and populating a risk database with the speed of the vehicle and the corresponding posted speed limit, wherein the risk database stores the speed of the vehicle data and the corresponding posted speed limit in a data field corresponding to the specific vehicle driver.

### CROSS-REFERENCE TO RELATED APPLICATIONS

This patent application claims the benefit under 35 U.S.C. § 119(e) of U.S. Provisional Patent Application No. 62/650,640, filed Mar. 30, 2018, which application is incorporated herein by reference.

### FIELD OF THE INVENTION

The invention broadly relates to vehicle sharing technology, more specifically to a cloud-based vehicle-sharing technology that matches users based on distance and schedule, and even more particularly to a vehicle-sharing technology that dynamically varies pricing based on utilization, driver behavior, and risk profiles.

### BACKGROUND OF THE INVENTION

Ride sharing services, such as USER and LYFT, permit drivers to pick up passengers for rides to a specific location. Drivers of these ride sharing services often use their own personal vehicles or rent vehicles individually from the ride sharing service. If the driver uses his/her own vehicle, it results in significant wear and tear to the driver's vehicle. Maintenance items, such as tire wear, fuel, brakes, are serviced more frequently. In some instances, drivers are unable to enter the ride share market due to the cost of insurance, gas prices, or the impact to their personal vehicle from the increase usage.

The ride share market would be benefited from a lean, self-managing community of drivers and vehicle assets. Drivers sharing specific vehicles for specific shifts create a Car Family, effectively splitting the cost of doing business between two or more drivers. A system to manage the drivers and assets would result in a more efficient system for ride sharing services. Drivers can schedule shifts of a vehicle and be charged a flat rate inclusive of fees such as insurance, fuel or batter charge, and maintenance. Moreover, optimizing use of system vehicles, especially hybrid/electric vehicles, will benefit the environment.

The trouble with such a system is the shear amount of data and asset management that is required to run an operational system. Drivers need to be investigated or vetted before being entrusted with a vehicle. Driver behavior needs to be tracked to verify passengers are receiving proper service and the vehicle itself needs to be tracked to verify the driver is not abusing the use of the vehicle. As a result, a system that intakes driver information and monitors driver behavior while driving is needed. A system to rate the risk profiles of certain key metrics to assess the risk of a driver, potential premiums or discounts associated with the risk profile, and threshold on when to suspend a driver's ability to assess the system/vehicle.

As can be derived from the variety of devices and methods directed at developing ride share services, many means have been contemplated to accomplish the desired end, i.e., optimizing the asset management and risk profile of the drivers using the ride share services. Heretofore, tradeoffs between vehicle management and risk tolerances were required. Thus, there is a long-felt need for a system to manage drivers and vehicle assets for a car share service. There is a further long-felt need for a system that assesses and actively tracks risk profiles of the drivers or users of the system. There is also a long-felt need for an application to provide a gateway for the driver and asset management system.

### BRIEF SUMMARY OF THE INVENTION

The present invention broadly comprises an application that interfaces with a user and back end asset management system.

In a further embodiment, the system manages assets and assigns assets based on requested user schedules.

It is a general object of the present invention to assess and track user and asset metrics to calculate a user risk score to protect other users and assets from users not following the prescribed guidelines and rules associated with using the assets.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a series of user interface screenshots detailing the process to enter sign-up information.

FIG. 2 is a user interface screenshot detailing the motor vehicle record and background check screens.

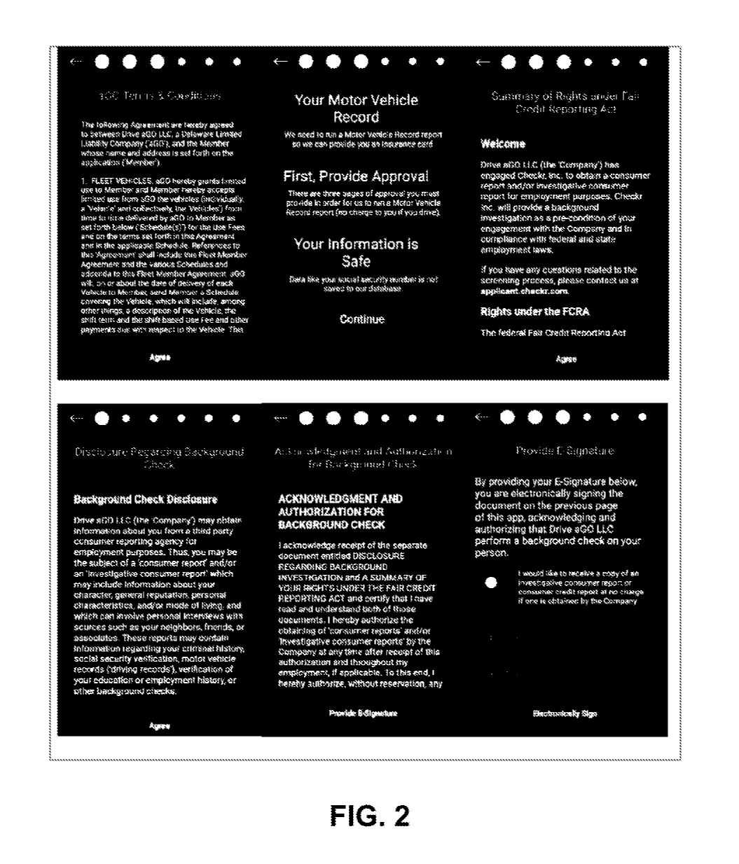

FIG. 3 is a user interface screenshot of the user scheduling and vehicle selection screens.

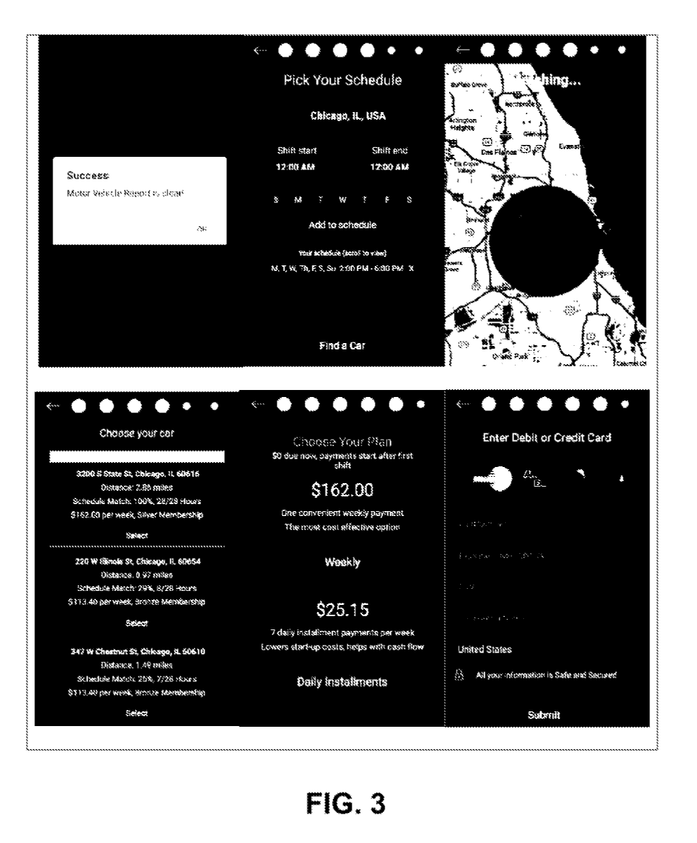

FIG. 4 is a user interface screenshot of the completion screens and schedule notification screens.

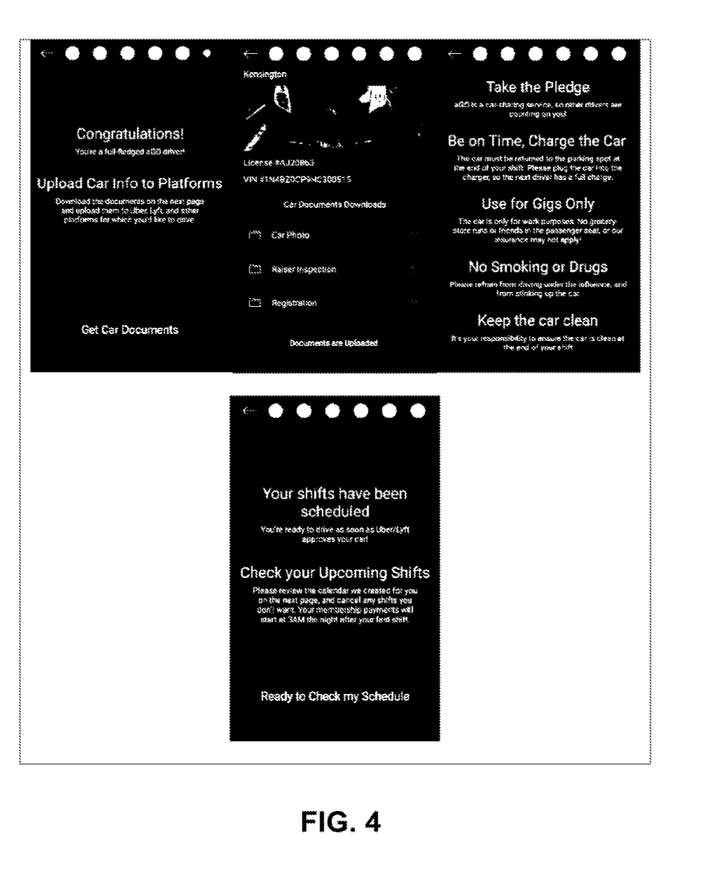

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “vehicle” is synonymous with terms such as “hybrid vehicle”, “Electric vehicle”, “EV”, “car”, “truck”, “combustion engine vehicle”, etc., and such terms may be used interchangeably as appearing in the specification and claims. Although any methods, devices or materials similar or equivalent to those described herein can be used in the practice or testing of the invention, the preferred methods, devices, and materials are now described.

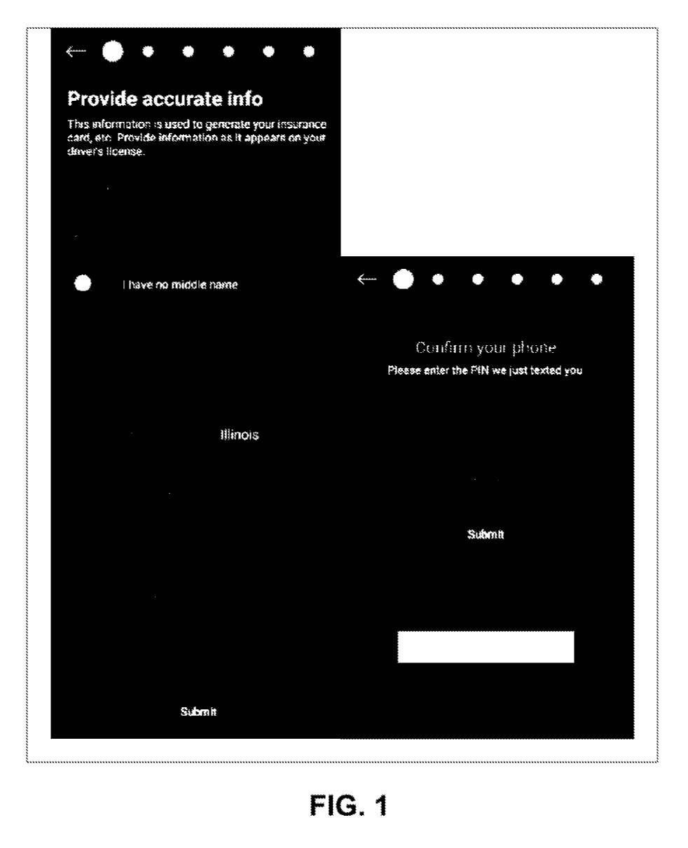

The instant invention involves a system and method to streamline car sharing to the ride-sharing market, such as USER and LYFT. Step 1 in the process is to have users (and prospective users) input their information into the Sign-Up screen of the instant invention, an application depicted in FIG. 1. The Sign-Up screen is preferably used by the user through a mobile device but can be used directly through a personal computer such as a desktop or laptop. For purposes of the instant application, a mobile device refers to, but is not limited to, a smart phone, tablet, cellular phone, or other device that has a passive or active access to the Internet. In addition, the term user is also referred to a driver.

During Step 1, the user inputs basic information such as name, telephone, e-mail address, driver's license number and state, and date of birth. Once the user submits the basic information, the front-end JavaScript validates the information, generates an over the air (“OTA”) device token, and submits the form to the server application programming interface (“API”). When received, the REST API validates the information entered by the user, creates a new user in the user table database, and exchanges the OTA device token for an access device ID through the OTA API. Next, the API saves the OTA access device ID to the database, generates a random 4-digit code that is communicated via Simple Messaging Service or text to the user to confirm the user's phone number, saves that 4-digit code to the database, and interprets and stores any “Signup Code” parameter, such as a referral-code entry, promotional-code entry, or automatically assigning the driver to a Car Family (i.e., the word for a car, parking spot, charger, and group of drivers) then returns a JSON response to the front-end.

When the server response is received, the front-end performs the following actions depending on the JSON being received: 1) report an error alert, 2) move the user to a confirmed phone number page, or 3) move the user to a pre-specified “business to business” onboarding experience.

Next, in Step 2, the user is routed to a page (also known as a screen or user interface) where the user will enter a 4-digit code texted to the phone number provided during the sign up process. This confirmation action verifies the user is the owner of the phone number entered and that the user will receive automated messages through the application. This confirmation process is critical given the services provided by the instant invention. In common applications, a confirmation is used to simply make sure the user owns or has assess to the email address or phone number used during on boarding. For the instant invention, the user's phone acts as a key to the vehicle being used for a particular shift. Accordingly, verifying the user is the owner of the phone verifies correct user is gaining access to the asset, or vehicle.

In Step 3, the instant invention runs a Motor Vehicle Report (“MVR”). The application runs a MVR on each user onboarded to a vehicle using the CheckR API. The CheckR API is a third party service with which the instant invention communicates, which performs the task of running a Motor Vehicle Report, confirming the applicant is of at least 21 years of age and meets any other criteria as defined by the business (for example, no more than 5 major offenses in the past 3 years). Prior to running an MVR, the user is provided several required forms in which they acknowledge authorization to perform a MVR and provide the necessary consents. Terms and conditions are also included in this section of pages in the UI.

The user's agreement to the terms, the timestamp of clicking the “agree” button, and the IP address of the user at the time of clicking the “agree” button, are saved to the database. This is to ensure compliance with all CheckR, state, and federal requirements. For the MVR results, the server parses the response and identifies any users that have either an unacceptable driving history or whose identify cannot be verified. Such users are placed on an error page. Administrators are alerted through the application because such an error requires manual intervention and/or indicates a fraud attempt.

The MVR results are also converted to a JSON matching the requirements of the Arity PreQual API. The PreQual API enrolls the user into the Arity system and is used to track driver behavior. The Arity PreQual API also generates a “driver risk score” or DRS, which uses their proprietary algorithm to compare a driver's MVR to all other drivers enrolled in their SDK, and create a numerical representation of their risk relative to all other drivers. This “driver risk score” is saved to the database, and modifies the internal “total risk score”, or TRS. The total risk score is also impacted by a driver's payment history and any incidents which occur while the driver utilizes the services provided through the instant invention. Incidents include, but are not limited to vehicle accidents, driver customer disputes, late or non-payment of membership fees, and criminal charges. A driver's total risk score impacts the cost of the driver's membership plan, including discounts or premiums.

The DRS is a variable tool in the instant invention. First, the DRS calculates a baseline score for each driver based on preliminary information. Then, the instant invention either updates the data used to calculate the DRS continually or at set frequencies. As a result, the DRS changes over time to accurately assess the risk profile of each driver as the driver uses the system and assets more frequently. The present DRS is compared to the driver's baseline DRS from onboarding.

Every user in the users table has a set TRS, which is a combination of several factors, including, but not limited to: payment timeliness, use of hard braking versus soft braking, speeding compared to speed limit, timeliness of vehicle return, motor vehicle record, and ARITY PreQual API Score. These factors continue to expand to for additional data points that monitor driver behavior and risk tendency. The TRS impacts the cost of the user's membership plan and optionally impacts the selection of Car Families returned from the “user/families” URI. The TRS is also used to automatically ban users, as well as disallow use of the “daily payment” system, which would require weekly pre-payments. Hard breaking, which reduces the lifecycle of the brake pads, is also evidence of a riskier style of driving. Hard breaking also reduces the impact of regenerative braking for electric vehicles, which is useful to recharges a vehicle's lithium battery.

Next is an example of a DRS and the impact of the driver's DRS when using the instant services provided under the instant invention. A new driver is loaded onto the system. The driver's background information, including driver's license number, generates a MVR containing a list of known violations within the past 5 years, which is subsequently used to generate a DRS. Typical Driver Risk Scores range from 300 (an unsafe driver) to 700 (a very safe driver). The mean is 500, which would result in a starting total risk score of 1. A DRS under 500 results in a starting total risk score of 1+(500 DRS)*0.002. A DRS over 500 results in a starting total risk score of 1−(DRS 500)*0.0002. The new driver inputs a driving schedule of 45 hours per week and is matched to a nearby Car Family costing $250 per week, or $35 per day. If the DRS is 700, or a prescribed threshold or range, the driver is assessed a 4% discount on the first payment, which correlates with a total risk score of 0.96. If the driver has a DRS of 300, the driver is assessed a 40% premium on the first payment, which correlates with a total risk score of 1.4.

A driver's baseline score is computed from their first day of driving. The instant invention, through the application, monitors variables of the driver's use of the vehicle. Variables include, but are not limited to: speed compared to speed limits, braking application (hard, soft, smooth), interaction with consumers, use of headlamps and windshield wipers at night, turn signals, and similar variables associated with safe driving mannerisms. If the variables portray the driver as a safe driver, the application provides a reduction to the DRS after day 1 of driving. For example, the driver's total risk score of 1.4 may drop to 1.38. If the driver then misses a payment for driving using the service provided under the instant invention, a 5% increase is added to the DRS. Here, the score would increase to 1.43. The percentage variances are based on the initial scoring of 1.00.

The instant invention, connected to each vehicle's onboard computer using a tablet or other mobile device, measures driver variables in real time. The use of an electric vehicle allows the instant invention measure variables such as braking speed, signal (turn/hazard) usage, and similar functions.

The driver's risk profile and associated DRS changes every shift and payment schedule. Accordingly, the DRS is continually updating to assess and properly attribute the risk profile associated with each driver using the instant invention. The driver's risk profile is an accumulation of the data associated with the specific driver, including the positive and negative attributes with their driving style and payment frequency, to name a few.

The risk profile impacts the user's pricing. The instant invention develops a unique risk profile for each user and learns the habits of the particular user to efficiently develop behavior changes for non-compliance with rules. For example, if a user is late with a payment, his/her risk score may increase from 1.0 to 1.1. Some users may not respond to a 0.1 increase. Then the risk score increases each day by 0.1 or other programmed or learned increment. If the user responds when the risk score increases to a penalty of a 0.50 adjustment (i.e. makes payment), the application logs the total adjustment level that resulted in the behavior change. The next time this specific user has a missed payment, the application will automatically set the risk profile adjustment to 0.50. Based on the prior payment issue, the application sets the new adjustment value that has a history of triggering the required behavior from the specific user. The application will bypass the 0.1 increments based on the history of the user and jump to a known trigger of a 0.50 adjustment value.

By learning the habits of each user, the instant application creates a unique user-specific risk profile. The application can more efficiently trigger a behavior change by assessing and learning at what pricing adjustment will create the change needed for the specific user. This will reduce the timing that a user is not complying with the rules as the application pushes the user immediately to a known adjustment threshold.

The DRS and driver risk profile was developed for the ride sharing driver market for the instant invention. However, the ability to monitor in real time user habits, frequencies, and background information, allow the instant invention to be applied wherever a risk profile of a user is necessary, especially when measuring real time data that is not ascertainable without the use of monitoring equipment and data.

This risk score is not only a verification of the driver's identity and barrier to entry, which protects company assets and inventory, it impacts the cost of the driver's membership plan much like an insurance provider would alter the cost of insurance cost. The risk score also allows the owner the ability to manage the spread of risk across multiple vehicles and Car Families. For example, some assets (e.g. a high end TESLA) may only be assigned to well-standing, proven drivers. While other assets (e.g. economical sedans) are assigned to Car Families with unproven, higher risk drivers. This ensures the highest level of customer satisfaction for long-term drivers, and allows the vetting of new drivers in lower-cost assets, effectively minimizing risk. It can also spread risk, to ensure a certain threshold is not surpasses for any given vehicle.

In Step 4, the user's schedule and Car Family is assessed and assigned, which are critical asset management and business development thresholds. At the first page of this user interface (“UI”), the user enters his/her address and preferred driving schedule.

When the page loads, the front-end sends a GET request to the “user/schedule” Uniform Resource Identifier (“URI”) of the REST API to populate the section of the page that lists the driver's input schedule. Performing this initial request for when a user already has an existing schedule allows handling drivers getting to this page from a “Suspended” screen, or by a user request to change Car Family or Membership Plan. A membership plan is based on the amount of time being reserved and frequency of payment, in most cases on a weekly basis.

The address input uses the Google Maps “Autocomplete” SDK to provide a list of addresses matching the user's entry. The front-end validates that any entry made in the address field is a valid Google Maps address, so that the address can be used with the Google Maps “Geolocation”, “Reverse-Geolocation”, and “Directions” APIs throughout use of the application.

The user selects a start time (i.e. 12:00 AM), end time (i.e. 4:00 AM), and the days of the week during which the user will drive.

The user does not select specific dates at this UI, only specific days of the week such as Monday through Sunday. Practically, the user selects weekly membership plans as the service provided through the application requires users (or drivers) with consistent driving schedules. The user schedule form locates a vehicle, sets up the user's schedule, which repeats, and automatically selects a membership plan that fits the user. While the application is intended for use with users that have a consistent weekly schedule for driving, the application is also equipped to handle “on demand” user requests, as described herein.

For example, if a driver fails to make his/her first payment, the total risk score of the driver would increase, causing all future payments to be more expensive. The driver's shifts would be cancelled, allowing the car to be used by others in the same Car Family. The driver would have the opportunity upon logging into the app to pay the outstanding balance, and would then be shown the “Enter your Schedule” and “Choose a Car Family” screens again. This effectively allows drivers to only pay 3-4 times per week, but always pay before driving again. Although this is not the ideal use of the instant invention and continued abuse of the system as such would result in permanent suspension (due to total risk score breaching the maximum allowable value), new drivers may benefit from this “on demand” use of the instant invention for a limited period of time.

Once the schedule form is submitted by the user, the “car finder” algorithm checks the next seven days of shifts for each vehicle in the inventory database, looking for vehicle availability during the new user's requested driving schedule. For example, if a user signs up, or reactivates his account, on a Monday, the user has the ability to enter a schedule of “12 AM 4 AM Tuesdays” to find the nearest Car Family available from 12 AM 4 AM on Tuesday, the next day. The application provides an option for “on demand drivers” but seeks to put drivers in weekly membership schedules.

After selecting a start time, end time, and days of the week, the user clicks the “Add to Schedule” button on the UI. This populates the “scheduling” table of the database. Upon receipt of a “success” response for the POST submission to the “user/schedule” URI of the REST API, the front-end then sends a GET request to the “user/schedule” URI to receive the new JSON of the user's schedule, updating the page asynchronously. Every schedule entry has a delete button, which sends a request to the server to remove the schedule entry from the user's schedule. This is also asynchronously updated on the UI.

Upon submission of the user schedule, the front-end validates that a valid address was entered by converting the written address to latitude/longitude using the Google Maps Geolocation API and confirming the absolute value of the longitude and/or latitude is greater than 0, and that at least one scheduling entry was created. For this to occur, the server has saved the user's schedule for long-term reference. The server then sends a POST request to the “user/address” URI for server-side validation, converting the address to a latitude/longitude using a mapping API, such as Google Maps API, and saving the address, latitude, and longitude to a database in the “users” table. If a latitude/longitude was not found by the Google Maps API, an error is returned to the front-end. If a success response is received, the front-end moves to the “Choose a Car Family” page. If an error is received, an Alert is routed to the UI displaying the “error” parameter from the server's JSON response. While Google Maps API is used herein, any mapping API can be used with the instant invention.

In Step 5, upon the page loading, the front-end sends a GET request to the “user/families” URI of the REST API. While awaiting a response, a custom animation is displayed to the user. The search can take over a minute to process in some cases due to the number of calculations being made and API requests being sent across all or part of the vehicle fleet.

During the search, the server first validates that a valid address is already saved to the user's table of the database, along with a latitude and longitude. If not, an error is routed to the user UI and no further processing occurs. The next function of the server is to isolate a subset of Car Families to search more closely for the end-user. For example, Car Families for specific cities or regions are searched to refine the optimal Car Family for the specific user. If the application was isolated to one city, e.g. Chicago, the search criteria is not as broad. However, the instant application is designed to have servers separated by region, for improved stability, speed, and/or to handle time-zone differences. Localization of servers being used will be either handled via Amazon Web Services (AWS) which has automatic load-balancing by region, or by the implementation of a load balancing server to which all traffic is routed to the appropriate Application Server. This allows for region-specific traffic (to speed processing), localization of data (for security purposes, separating user data across multiple servers minimizes the impact of a security event), and region-specific redundancies (back-up and fail-over servers which are region-specific, allowing quicker boot-time and quicker switch-over in the event one of our servers goes down.

In an exemplary embodiment of the instant invention, the server will use the latitude/longitude and/or the user's time-zone into account in selecting a Car Family. The separation of servers geographically will directly correlate to defining this first sub-set of the entire vehicle fleet in all processing requests. For example, there is no need to estimate the distance between a user and a Car Family in New York City, if the address the user entered is in Chicago. This high-level grouping of Car Families could require at least one more layer added between the general region and estimating the distance between the user's address and the Car Family. Processing-wise, it is more efficient to request a region-code for a Car Family from the server than it is to request a latitude/longitude for a Car Family from the server, and estimate the distance between the user's input address and the Car Family.

In an exemplary embodiment, the algorithm first excludes any results that are greater than 5 miles away from the user's address. If no results are found, the algorithm then runs again excluding any results greater than 10 miles away from the user's address. If no results are found, the algorithm then runs again excluding any results greater than 20 miles away from the user's address. If no results are found, the algorithm then runs again excluding any results greater than 40 miles away from the user's address. This ensures the quickest load time for users in major metropolitan areas who would have dozens of matches within 40 miles (pushing load times to 2+ minutes), while also providing results to users in suburban areas, which may require commute to the nearest Car Family. In other exemplary embodiments, the search criteria will be region-specific, based on the user's input address, and/or the Car Family's address. For example, a user in Chicago, Ill., with many options for Car Families in Chicago, does not need to see search results for a Car Family in Naperville, Ill. However, a user in Naperville, Ill. is more likely to want to see Car Families in Chicago listed as options. In yet another exemplary embodiment, the user will have a series of options to see how broad the search results span in pairing the use with available Car Families. This will limit calculating the distance between the user and a given Car Family when unnecessary, save processing speed and server requirements, and shorten the amount of time the end-user is awaiting for a server response.

Once the set of Car Families to be processed are defined by the server, the algorithm estimates the distance between the user and the Car Family. The address, latitude, and longitude, and time zone of each car family is saved to database and used in these calculations. In most instances where the REST API calculates the distance between two locations, it uses the Google Maps API to calculate the distance based on driving time and miles driven. In an exemplary embodiment, the instant invention estimates the distance between a user and a Car Family using a latitude/longitude comparison. This calculation is not actual driving time, but the literal distance between two points on a two-dimensional plane.

The function for calculating the estimated distance of two points used by the server in these calculations is as follows:

function estimateDistance($lat1, $lon1, $lat2, $lon2)
{

$theta = $lon1 − $lon2;
$dist = sin(deg2rad($lat1)) * sin(deg2rad($lat2)) +
cos(deg2rad($lat1)) * cos(deg2rad($lat2)) *

cos(deg2rad($theta));

$dist = acos($dist);
$dist = rad2deg($dist);
$miles = $dist * 60 * 1.1515;
$unit = strtoupper($unit);
return $miles;

}

The curvature of the earth is included in this calculation, but the random topographical differences (valleys and mountains) are not. This equation assumes the Earth is a perfect sphere, which it is not. This equation also assumes that distance is calculated in a direct line, which does not accurately calculate the driving distance between two points (as the driving directions between two points is rarely a straight line). However, this function is much faster than communicating with the Google Maps Distance Matrix API, and the results are accurate enough to use in this scenario.

Once the estimated distance of a Car Family from the user is calculated, certain Car Families are excluded from further calculations as being too far away, based on a preset and modifiable threshold distance. The server loads the remaining Car Families into an array that is compared to the user's scheduling entries, as provided in Step 4.

For each scheduling entry, the server checks the “shifts” table of the database for a shift that conflicts with the scheduling entry in the same vehicle that is not cancelled. A shift is a reserved time in which a driver is scheduled to use a vehicle as part of the Car Family. If no results are found, the hours are added to the running count of “available hours”. If a result is found, the shift is broken into one-hour segments. Then, for each one-hour segment, the server checks the “shifts” table for a shift that conflicts with that one-hour segment. If no results are found, one hour is added to the running count of “available hours”.

Thus, the server efficiently calculates hour many hours in the next seven days during the times the user entered in “Step 4” are available on each car in the fleet. That number is divided by the total number of hours the user is requesting, calculating the “availability rating” of the car (e.g., 25/50 hours available, 50%). The results displayed in Step 3 to the user are first sorted by distance, then availability.

The list is optionally weighted to account for spreading of risk throughout the fleet, based on the Driver Risk Scores (“DRS”) detailed herein. In this option, a meta “total risk score” is implemented, which is impacted by distance, availability, and other factors. The weight of each factor is determined by a centrally-administrated “weight factor”, that combines each variable's value in relative terms. In this option, the results displayed to the user are ordered only by the total score.

The ordered results are sent as a JSON response to the REST API request, and displayed as a list to the end-user. The best result is flagged to the user and displayed as “suggested”. The distance and availability are shown to the user, along with the name of the vehicle and Car Family.

If a nearby vehicle is not found, the driver's address and schedule is saved to the database. This allows administrators to review the demand for vehicles, and deploy vehicles where there are multiple drivers with matching schedules waiting for a vehicle. This is how the instant invention automates expansion based on user demand. Once enough drivers who are within an acceptable distance of one other with well-matched schedules are waiting, the administrator identifies the need, procure a parking spot, install an electric charger (if necessary), prepare the vehicle, and deploy it to the new Car Family.

When a user chooses a Car Family, the user is automatically assigned to a weekly membership plan specific to the number of hours they committed to driving each week. For example, a driver who searches for 50 hours a week, then chose a family that supports 27 hours per week, will be automatically assigned to the Silver membership (25 hours per week). This information is saved to database by the server, after the user selects a Car Family, sending a POST request with the Car Family ID to the REST API's “user/family” URI.

In Step 6, the user selects a payment frequency using the UI. Membership plans are weekly, and each tier sets a limit on the number of hours a driver can schedule with the vehicle each week. The daily installment plan allows drivers to pay for their weekly membership on a daily basis (starting the day after their first shift), allowing a new entrepreneur to launch his/her business without any start-up cost whatsoever. A user's cost of doing business is be taken straight from their Uber/Lyft revenue, because of their daily pay-out cards. When adding a credit/debit card to the system, all a driver needs to do is add the card they received from Uber/Lyft. Users also have the option of selecting a “weekly” membership payment plan, for which they receive a discount.

In Step 7, the user enters his/her payment source. The UI collects the user's card number, expiration month/year, and CCV and sends it to the Stripe API, which validates the card and creates a Stripe Customer. The Stripe Customer ID is saved to the database and used to charge the user for the duration of their membership plan.

In Step 8, the instant invention automatically generates an insurance card, picture of the vehicle, vehicle registration, and an inspection form after the driver joins the Car Family. This information is everything required for the driver to add the car to his/her UBER/LYFT profile, or any other related service. In an exemplary embodiment, the instant invention automates the process of uploading this vehicle information for drivers through the USER Fleet program or similar program.

Next, the driver the application displays a page to the driver using the UI that details critical rules when using the services provided through the instant invention. Examples include, but are not limited to: returning the vehicle after your shift and ensuring the vehicle is clean for the next driver. Once the rules page is displayed, the followed page informs the driver that they are now full-fledged drivers. When the final page loads, a request is sent to the REST API's “user/shifts/schedule default” URI which uses the schedule the driver entered in “Step 5” to schedule shifts on repeat. Therefore, the final UI prompt informs the user of their shift schedule to ensure that the driver cancels any shifts not being used, and adds any shifts that are missing. On click-through, the driver is brought to the driver-homepage, a screen that lists all the driver's upcoming shifts in a calendar-view.

Another aspect of the instant invention is the Shifts Screen. Once a driver is onboarded, the application brings a calendar system to management assets used through the application. Generally, asset-management systems link users to devices to contacts. The missing piece to this puzzle is allowing multiple users to share an asset across pre-scheduled time periods, and automating alerts in the event an asset is not transferred across users.

A driver homepage displays a calendar of driving shifts for the Car Family vehicle, which is shared by the drivers in the Car Family. The vehicle share is similar to office employees sharing a conference room. The conference room can only facilitate having one meeting at a given time. The instant invention schedules the various shifts of the drivers for the singular asset, the vehicle. When the Shifts screen is loaded, an API request is sent to the “user/shifts” URI of the REST API, which populates the page with a list of shifts. Upon clicking a shift, the user is given the shift details, which includes systematically generated instructions, start/end location, and start/end time. In an exemplary embodiment, a first driver finishing a shift delivers the vehicle to the second driver that is scheduled to use the same vehicle. The second driver can then optionally transport the first driver to a desired location, e.g. home.

When the user creates a new shift, the user sends a date, start time, and end time through the UI of the instant application. In the event the end time is lower than the start time, the system assumes the end date is the day after the start day. The user can also specify “repeat” and select specific days to repeat the shift. Upon receipt of the user's new shift request, the server verifies the user authentication token and searches for any conflicts that would prevent the shift from being created (e.g. another user's shift overlaps). A series of rules are either checked or skipped, based on triggers in the users table which allow or disallow a user to create shifts in exception to those rules. Sample rules include, but are not limited to:

Sleep check
Due to the heightened risk of a vehicle not being returned or other policy breached by drivers between the hours of 3 AM-5 AM, and the lower price of electricity between those hours, the default is for drivers to be restricted from scheduling shifts between the hours of 3 AM-5 AM.

Monopoly check
Unless the user has been specifically allowed to ignore monopoly checks by an administrator, the server checks for any shifts within 8 hours of the shift being created. Users cannot have two shifts within 8 hours of one another, due to the heightened risk of drivers employing the vehicle in a tired and distracted state.

Daily Hourly Limit
Every membership plan has a maximum number of hours per day that a driver can schedule. Unless the user is specifically placed in exception to this rule, the driver will receive an error message if the shift being created would cause the user to be in excess of his/her daily hour limit based his/her membership plan. These limits are managed and set by the administrator.

Weekly Hourly Limit
Every membership plan has a maximum number of hours per week that a driver can schedule. Unless the user is specifically placed in exception to this rule, the driver will receive an error message if the shift being created would cause the user to be in excess of his/her weekly hour limit per his/her membership plan. These limits are managed and set by the administrator.

In the event a shift is on repeat but the original shift could not be created due to a conflict or any of the other errors detailed herein, the application will still attempt to create the repeating shifts wherever it would not cause an error or conflict. Repeat shifts are processed by breaking each day of the repetition into separate entries to allow the shifts to fail individually. Each repeat shift is entered into the “repetition” table of the database. Based on the present threshold, which can be modified as needed, Shifts can only be scheduled 30 days in advance. As a result, a server-side process runs every morning to schedule any repeating shift entry that should occur within the 30 day look ahead schedule. Upon submission, each daily repeating entry is sent to the same “user/shifts” URI as a separate API request until the 30-day limit is exhausted.

Whenever a shift is added to the database, the OTA API generates a BLUETOOTH token for the vehicle and user's access device, available at the time of the shift only, with a 30-minute grace period, allowing the user to unlock/lock the vehicle only during the times he/she has a shift. Examples of a user's access device include but are not limited to a cellular telephone, tablet, key fob, or other similar electronic device.

In a exemplary embodiment of the instant invention, “partial-shift scheduling” permits altering a shift to fit a conflicting shift if within prescribed limits, such as time overlap. In another exemplary embodiment, the instant invention implement a “shift alteration offering” in which users are offered discounts to extend their shift slightly in order to more efficiently match with other drivers. As more drivers are on boarded and the territory expands, a shift scheduling algorithm is necessary to perform these tasks as manual input/calculation is not efficient not feasible on such a large scale given time constraints.

When a shift is scheduled, the server checks Car-Family-Level settings to see if the vehicle should have “shift padding” enabled. The two concepts of “shift padding” and “driver swaps” are mutually exclusive. Shift padding is for cars like the Nissan Leaf, with a low battery utilization rating. Shift padding is when every shift is “padded” with a 2-hour shift for the vehicle to charge. Since the vehicle must be charged rather consistently, drivers lose time shift-swapping because they are forced to charge the vehicle during their shift. However, cars with higher battery yield like the Chevy Bolt do not require shift padding, which means drivers can start a shift as soon as the Car Family prior driver ends their shift.

When this occurs, the instant invention initiates a “shift swap” in which the first driver goes to the address entered in “Step 3” by the second driver, the second driver begins his/her shift, but begins by bringing the first driver to the address he/she entered in “Step 4”. This effectively removes driver parking from the equation entirely, as well as the driver's commute to the car. Driver no longer need to drive to and drop off their personal vehicle to parking lot while they pick up the vehicle to be used for the Car Family. The next shift driver in the Car Family takes the prior shift driver to a preselected location.

By creating the administrative layer for shift swaps, rather than integrating directly with the type of vehicle, we can also manage the existence of shift-swaps based on driver ranking. For example, a long-term, proven driver is more likely to be on time for the shift-swap than a brand-new driver. In an exemplary embodiment of the instant invention, management of shift swaps are automated, based on the “total risk score” of the drivers involved. This creates the need for “driver to driver feedback ratings”, in which drivers provide star-ratings of other drivers after each shift. This will in-turn influence drivers' “total risk scores”, which influence payment and the availability of shift-swaps in the Car Family.

### OTA SDK—Bluetooth and 3G Unlock/Lock Integration

Drivers are able to unlock the vehicle and enable engine start using the application of the instant invention, which will only work if the driver has a shift scheduled. The driver does not need to take possession of a physical key or key fob or transfer the physical key/fob to the next driver for the next shift. Presently, the application uses two methods of unlocking/locking/enabling-engine-start for the vehicle: 3G, and Bluetooth. However, any secure over the air signal will achieve the same results.

3G unlock requests are sent to the REST API, which checks that the user has a shift currently active. If the user does has an active shift, an API request is sent to the OTA REST API, sending the appropriate request. Because these requests require 3G connection between the OTA module in the car and the OTA server, as well as the user's access device and the server, the instant invention offers Bluetooth Unlock/Lock integration.

When a user logs into the application, a request is sent to the REST API's “user/ota_key” URI which returns the ID of the next BLUETOOTH key. When the user opens the BLUETOOTH Unlock/Lock page, that BLUETOOTH Key is used to send an SDK Request to scan for the OTA module and automatically connect via BLUETOOTH. Once connected via BLUETOOTH, the user sends UNLOCK AND ALLOW START or LOCK DOORS requests via the OTA SDK. This allows a user without a 3G connection to unlock/lock/enable-engine-start even without a network connection, as long as the user had a network connection when he/she authenticated to the application since a connection to the REST API is required in order to retrieve the ID of the next BLUETOOTH key.

### ARITY Driving Behavior Integration

The ARITY SDK is triggered by a background process on the tablet mounted to the vehicle. Every vehicle connected to the instant application, i.e. the inventory, includes a mounted tablet and cellular data plan. The tablet acts as a tertiary GPS module, and provides all the independent applications drivers need to run a rideshare business, e.g. UBER, LYFT, etc. The instant invention application allows the driver to start the engine, which then launches the SDK. In an exemplary embodiment, the application provides PUSH notifications to drivers, alerting them of nearby events which result in more fares, when they should switch to a different platform (for example, if USER is surging), notifications when their shift is ending or the vehicle's battery/charge is getting low, and even providing feedback when the driver speeds or utilizes the brakes too hard. In yet another exemplary embodiment, tablets are installed for passengers in the back seat(s) of the vehicles, to provide advertising, a way to tip the driver, and a portal for a passenger to become a driver. The instant application provides location based advertising to users and passengers. Based on the user specific data, advertising is targeted to specific groups of users, in addition to known demographics such as age and sex. Advertisers have the option of providing targeted ads to passengers in the user's vehicle spending on the location of the passenger and their accumulated data profile.

ChargePoint and evGO Integration

The ChargePoint and evGO applications replace the need for an RFID card to start a charge an electric car charger. Their main difference is that the ChargePoint network have “slow chargers”, which are cheaper but require 4 hours to fully charge a Nissan Leaf. These are only used at parking spots, and only at parking spots where a charger provided by the instant invention is not installed. The evGO network is for Quick-Chargers, which charge a Nissan Leaf in 20 minutes. These are for “on the go” charging. The instant invention integrates with these APIs and have their independent applications installed on the tablets, so drivers can arrive at a charger, open an application, which uses current location data to find the nearest charger, and immediately initiate a charge.

### GPS Monitoring

The OTA module also provides GPS coordinates on a regular basis. The ARITY SDK acts as a secondary GPS tracking device as well. The server merges these GPS coordinate feeds into a single “heartbeat” feed, which is used to track the asset at any given time. Server-side scripts monitor vehicle pick-ups and drop-offs by targeting every shift as it begins and ends (e.g. twice: 30 minutes and 90 minutes after a shift change), uses Google Maps API to calculate the distance from the vehicle and its correct location (the address, latitude, and longitude of the parking spot as saved to database and managed by administrators) and automatically notifies the user and administrator that the vehicle is either not returned or a shift has not started as scheduled.

### Charge Percentage and 12V Battery Monitoring

The instant invention's server-side scripts also reduce the risk associated with driving an electric vehicle. The ability to monitor and quickly find a charging station reduces and/or eliminates the “charge anxiety” many new electric vehicle drivers face. The unlocking mechanism connected to the OBDII port tracks information about the vehicle, including mileage, GPS, remaining lithium charge, 12V battery charge, and much more. This information is monitored to take automated, proactive measures to ensure a positive customer experience and avoid human error. In an exemplary embodiment, once the vehicle battery falls below a certain threshold, the application computes the time to the closest recharge station the amount of charge to get there. In the event the driving distance is greater than the remaining miles of charge left on the vehicle, administrators and the end-user are notified so Roadside Assistance (a tow to the nearest evGO quick-charger) can be proactively initiated.

### Incident Report and Service Request Management

The application also provides a front-end for Incident Report and Service Request management. Users complete an incident report or service request form. Once transmitted through the application, the results are triaged to the administrators who use the administrator application to review, approve, and automatically triage the necessary response to the incident report and/or service request. Most issues are automatically sent through the application to on-demand vendor “marketplaces” that will fill a job that the driver needs, e.g. changing a tire. The instant invention saves the information of each work order sent to an on-demand worker, including feedback from the customer, to weigh the automated triaging to a group of known, proven on-demand workers. This provides more reliable responses for future work from proven workers or vendors in the marketplace.

### Electric Car Data Collection

The scope of the instant invention provides for detailed data collection of electric vehicle performance. The degradation of assets being measured in high-use, real-life scenarios is coupled with driver behavior. This information is largely lacking in the greater ride-share market, as the impact of being an Uber/Lyft driver is usually simply correlated to being a taxi driver. The information made available in this regard is currently inadequate for many insurance providers, and instant invention makes strides to alleviate the lack of information for the benefit of the industry.

Asset inventory inspections are a cornerstone of asset management, particularly as it relates to the car-rental industry. However, the instant invention reduces these costs by establishing small groups of drivers (Car Families) that use the same vehicle, every week. From an asset management perspective, drivers treat their vehicle like a personal work-space. The driver keeps the vehicle clean and reports any issues with the vehicle because it is in their best interest to have a clean, operation vehicle. Otherwise, the driver's passengers would complain, and their UBER/LYFT profile would suffer. In addition, the next Car Family shift driver would report the issue, which would impact the risk score of the prior driver. As such, assets under the instant invention do not require routine inspections, as customer-feedback and data-collection provides all the information necessary to keep assets in acceptable condition.

Contractor oversight and misuse of assets are also self-managing obstacles. If a driver does not return the car or uses it for unauthorized purposes, automated alerts are sent to application administrators as well as the drivers who are not adhering to policy. In addition, the UI makes it simple for other drivers of the same Car Family to routinely alert administrators.

### Use in Other Sectors

The impact of shared assets on an asset management system, and the use of both preemptive and actual risk-scoring to alleviate the managerial functions of said asset management systems, is an emerging concept in more than the ride-sharing industry. The instant invention can be employed at schools, where multiple students require a calculator or laptop for a specific class. One would simply replace Car Family “shifts” with class-periods, to ensure the asset is only deployed to a single student at a given time. As such, an exemplary embodiment of the instant invention repackages asset management system for use with multiple device types, with open-ended configurations that allow use of the instant invention with other types of assets. This would be bundled with packages of asset-types, such as “laptop”, “vehicle”, “smartphone”, etc., each of which has its own server-side configuration for automated managerial functions.

Moreover, the metrics used for assessing the risk profiles for the users can be used modified for use in other industries where risk assessments are critical to business success. Example include the insurance market and credit card companies. The ability to use behavior metrics, across any platform, not only driving, enables businesses to assess risk based on active data, not passive data.

### The Insurance Market

Drivers benefit from special insurance deals, which are cheaper than the driver's standard insurance rates as an individual. This is the slowest portion of the market to evolve, due to lack of data gathered by insurance companies. The instant invention gathers the data necessary to push for change in the insurance market. In the ride-share market, there are four distinct periods of insurance: UBER/LYFT is not open, UBER/LYFT is open but no fare accepted, Uber/Lyft fare accepted but no passenger, and UBER/LYFT passenger is in the vehicle. The ride-share platforms (i.e. UBER/LYFT) insure the vehicle as long as their independent application is open, to varying degrees, which allows insurance provider affiliated with the instant invention the unique opportunity to insure a vehicle only when it is parked.

### Payment Processing

The user's table includes a column named “platinum_expires”, which is the unix timestamp of when the user's next membership payment should occur. In essence, the next membership payment should not occur prior to that unix timestamp. The default is NULL. Every morning at 3 AM, or another specific time, the system checks every driver who belongs to a Car Family that is not in inactive status. Inactive status occurs when an incident is reported which takes the vehicle offline (usually by an administrator), Car Families are set to “inactive” until the incident is resolved.

If the driver's platinum_expires is NULL (or less than one), the system checks if the driver had a shift in the previous 24 hours. If yes, the user is charged for their membership plan and platinum_expires is set to either one day or one week in the future (depending on the user's chosen “Payment Frequency” in “Step 6”). If platinum_expires is greater than 0 and greater than the current Unix Timestamp, the user is charged for his/her membership plan. When charged for a daily membership plan, the user's platinum_expires is set to a day in the future. When charged for a weekly membership plan, the user's platinum_expires is set to a week in the future. If the user is the result of a business-to-business relationship, a new set of rules are implemented based on the requirements of the relationship. For example, all drivers may be charged $3.50 for every hour they drove the week prior, and they are charged every Monday. Other administrative accounts may be used for administration fees. For example, a business to business relationship may pay a $100/month administration fee for each active vehicle assigned to them, and a centralized administrative account is charged that fee (using the same “platinum_expires” logic and a unique membership plan that triggers the server to charge for administrative fees instead of a standard membership plan).

If a user misses a payment, he/she is suspended. This cancels the user's future shifts, which allows other users to schedule the car during previously reserved times, and restricts the user from scheduling any shifts until reactivated. The user's user_type (as stored in the “users” table of the database) is changed to “suspended”, which prevents any future payments until the user's account is reactivated. The “suspended” user_type also triggers the front-end to provide a unique page for suspended users. A missed payment also increases a user's “payment risk score”, which impacts his/her “total risk score”. Whenever a user successfully completes a payment, it decreases his/her “payment risk score”, which impacts his/her “total risk score”. The user is informed of these changes through email for a successful payment (including the new cost of his/her membership plan), and by text message for unsuccessful payments (including the new cost of his/her membership plan). Communications preferences are modifiable based on user and application preference, e.g. email, text message, and PUSH notifications.

### User Suspension Handling

Users who are suspended that log into the application have a specific “suspended” home-screen. This page displays the reason they were suspended (as per the “suspended” table of the database, which houses the user ID, amount required to pay for reactivation, and a code that identifies the reason for the suspension) and provides options moving forward. Reasons include, but are not limited to:

Banned
These users have no options or buttons on the page. Banned users receive notice that they are banned from the application and instant invention and are warned that it is a felony in some states to attempt to sign up again using false information.
   Missed payment
These users are given the option to change their payment method (enter a new debit/credit card), and/or to complete their missed payment using the current card on file. Upon successful payment, if the user has been suspended for less than 12 hours, their account is reinstated with no change to their schedule or Car Family. If the missed payment was more than 12 hours prior, the user is brought back to the “Enter your Schedule” page (Step 3 above), searches for a new Car Family, enters payment frequency, then gets the “rules” page and the “check your shifts” page again.
This effectively allows a user to drive for one day to try the system, default on payment, then pay their payment to find a car available that same day. Then repeat, and use our system as an “on demand” car rental service. Use of the system in this manner results in a heightened price for the user due to the increase in their total risk score from the missed payments.
   Unknown
These users are given a button to request a free activation. This messages administrators and alerts them to review the history, and either ban or reactivate the user.
   User Choice
A user that clicks “cancel membership” has all the same options/buttons as a user who missed a payment.

### aGO Business to Business

The instant invention and application are capable of being customized for specific business-to-business relationships. For example, our one Business to Business relationship isolates each vehicle for one driver, and allows the driver to schedule at time of the day or week at their request. These drivers pay for the vehicle by the hour, and excess time is paid for by the business owner to ensure the vehicles are being utilized for a minimum number of hours per week. Due to the specific business to business relationship, drivers skip most of the onboarding experience, as they are sent directly to a specific vehicle with a specific membership plan and frequency.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A method for determining the risk profile of a vehicle driver, which comprises:
monitoring payment timeliness of the vehicle driver;
populating a risk database with the payment timeliness, wherein the risk database stores the payment timeliness data in a data field corresponding to the specific vehicle driver;
monitoring braking style of the vehicle driver;
populating a risk database with the braking style of the vehicle driver, wherein the risk database stores the braking style data in a data field corresponding to the specific vehicle driver, the braking style data comprises: the speed of the vehicle, pressure on a vehicle brake pedal by the vehicle driver, and the time the brake pedal is engaged by the vehicle driver;
monitoring the speed of a vehicle being driven by the vehicle driver compared to the posted speed limit; and
populating a risk database with the speed of the vehicle and the corresponding posted speed limit, wherein the risk database stores the speed of the vehicle data and the corresponding posted speed limit in a data field corresponding to the specific vehicle driver.
